(19) United States
(12) Patent Application Publication
(10) Pub. No.: US 2010/0260965 A1
(43) Pub. Date: Oct. 14, 2010

(54) MULTI-LAYERED MOLDED ARTICLE WITH MOISTURE PROTECTION

(75) Inventors: KUN-TSAN WU, Shindian (TW); LI-WEN TIEN, Shindian (TW)

Correspondence Address: Altis Law Group, Inc.;ATTN: Steven Reiss, 288 SOUTH MAYO AVENUE, CITY OF INDUSTRY, CA, 91789, US

(73) Assignee: FIH (HONG KONG) LIMITED, Kowloon (HK)

(21) Appl. No.: 12/821,272

(22) Filed: Jun. 23, 2010

Related U.S. Application Data
(63) Continuation-in-part of application No. 12/168,222, filed on Jul. 7, 2008.

(30) Foreign Application Priority Data
Dec. 21, 2007 (CN) 200710203350.8

(51) Int. Cl. B32B 3/02; B32B 3/08; B32B 25/20

(52) U.S. Cl. 428/83; 428/192

(57) ABSTRACT

A multi-layered molded article includes a main body and a protective member. The main body includes a decorative layer and a substrate moldingly bonded to the decorative layer. An intersection is formed between the decorative layer and the substrate around the main body. The protective member surrounds at least substantially the entire intersection between the decorative layer and the substrate to prevent moisture from entering anywhere between the decorative layer and the substrate.

### CROSS-REFERENCE TO RELATED APPLICATION

This application is a continuation-in-part application of U.S. Ser. No. 12/168,222, filed Jul. 7, 2008 the contents of which are hereby incorporated by reference. The patent application Ser. No. 12/168,222 in turn claims the benefit of priority under 35 USC 119 from Chinese Patent Application 200710203350.8, filed on Dec. 21, 2007.

### BACKGROUND

1. Technical Field

The present invention relates to multi-layer molded articles.

2. Description of Related Art

Molded articles, such as molded shells, are widely used in many technologies. One example is a molded shell used with a portable electronic device (e.g., a mobile phone) for protecting internal electronic components. Another example is a molded shell used with furniture (e.g., a mini sofa) to provide decoration.

The molded shells may include a plastic substrate having some kind of decorative and/or protective (hereinafter “second”) layer formed thereon. The molded shell may be made using an insert molding process. The second layer is placed in the mold cavity and then bonds to the molten plastic, injected into the mold for forming the substrate.

However, moisture may easily enter between the shell and the second layer, making the second layer detach easily from the shell.

Therefore, there is room for improvement within the art.

### BRIEF DESCRIPTION OF THE DRAWINGS

Many aspects of the multi-layered molded article can be better understood with reference to the following drawings. The components in the drawings are not necessarily drawn to scale, the emphasis instead being placed upon clearly illustrating the principles of the multi-layered molded article. Moreover, in the drawings like reference numerals designate corresponding parts throughout the several views.

FIG. 1 is a perspective view of a first exemplary embodiment of a multi-layered molded article.

FIG. 2 is a perspective view of a main body shown in FIG. 1.

FIG. 3 is a perspective view of a protective member shown in FIG. 1.

FIG. 4 is a cut-away view of the article shown in FIG. 1.

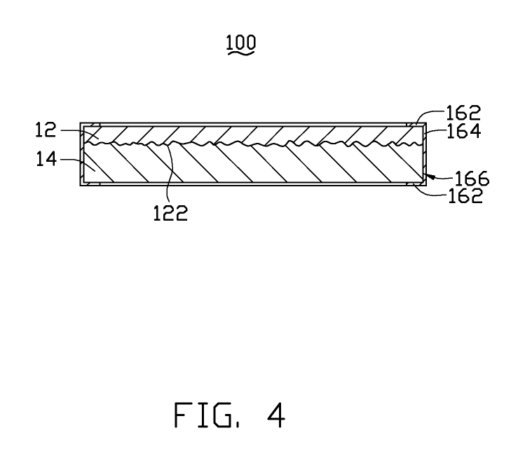

FIG. 5 is a cut-away view of a second exemplary embodiment of a multi-layered molded article.

### DETAILED DESCRIPTION

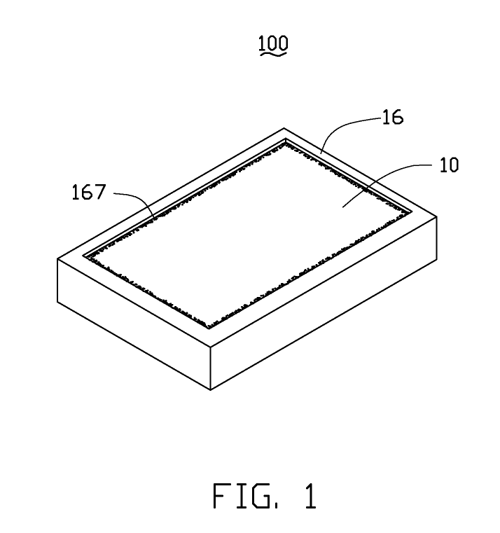

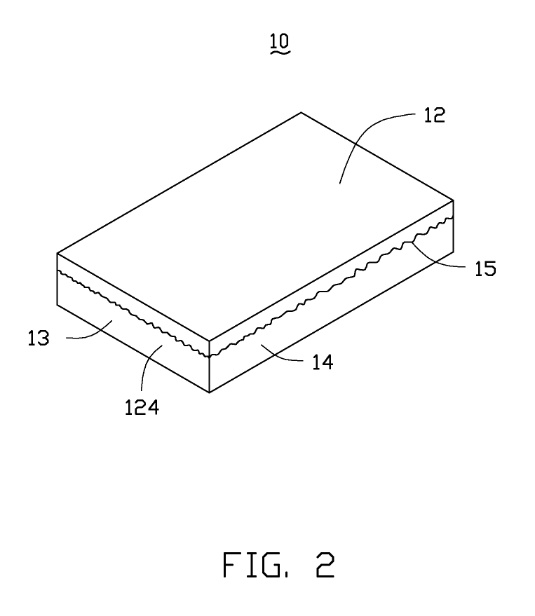

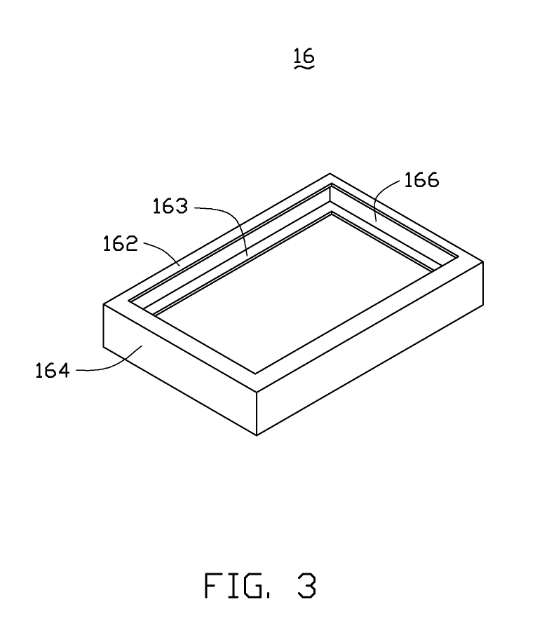

Referring to FIG. 1, in a first exemplary embodiment, a first multi-layered molded article 100 is shown. Also referring to FIGS. 2 and 3, the article 100 includes a main body 10 and a protective member 16 surrounding of the main body 10. The main body 10 includes a decorative layer 12 and a substrate 14 moldingly bonded to the decorative layer 12.

The decorative layer 12 can be made of a flexible material. Exemplary flexible materials include leather (natural and artificial), all types of fabrics, woven clothes, textiles, and nylon. One surface of the decorative layer 12 acts as a bonding surface 122. The bonding surface 122 should have a rough or coarse surface, formed by, for example, a plurality of tiny pores or projections (schematically shown). For some flexible materials, the pores and projections of the bonding surface 122 may be a natural property of the material. For other flexible materials, the pores and projections may be formed by grinding or sandblasting the bonding surface 122. The tiny pores and projections of the bonding surface 122 interlock with the molten material used to make substrate 14, thereby increasing the bonding of the decorative layer 12 to the substrate 10.

The substrate 14 can be formed by injection molding a moldable material. The moldable material can be any of plastic, rubber, and silicone. The plastic material can be any of polyvinylchloride resin (PVC), polyethylene terephthalate (PET), acrylonitrile-butadiene-styrene (ABS), polycarbonate (PC), polyimide (PI), liquid crystal polymer (LCP), polyetherimide (PEI), polyphenylene sulfide (PPS), polystyrene (PS), polypropylene (PP). In particular, ABS and PC exhibit good adhesion to many softer materials.

In this exemplary embodiment, after the decorative layer 12 is bonded to the substrate 14 to form a semi-manufactured article, the semi-manufactured article cut to form a main body 10. Referring to FIG. 2, where the exemplary main body 10 comprises a rectangular solid, the main body 10 includes four connected surfaces 124. An intersection 15 is formed between the decorative layer 12 and the substrate 14 around the main body 10 on the connected surfaces 124.

Referring to FIG. 3, the protective member 16 is a flexible frame, and includes a top rim 162, a bottom rim 163 and four sidewalls 164 connecting the two rims 162 and 163. The top rim 162, the bottom rim 163 and the sidewalls 164 cooperatively define a groove 166 around the inside of the protective member 16. The surfaces 124 of the main body 10 are received in the groove 166, and contact the inside of the sidewalls 164. The protective member 16 is securely attached to the main body 10 and seals the intersection 15 between the decorative layer 12 and the substrate 14 at the connected surfaces 124. Thus, the protective member 16 can prevent moisture from entering between the decorative layer 12 and the substrate 14. To further prevent moisture from entering from the top rim 162 and the bottom rim 163, an adhesive 167 can be coated on the edges of the top rim 162 and the bottom rim 163.

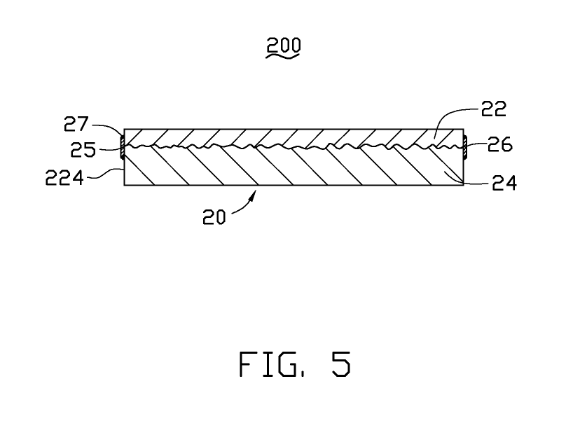

Referring to FIG. 5, in a second embodiment, a second multi-layered molded article 200 includes a main body 20 and a protective member 26. The main body 20 includes a decorative layer 22 and a substrate 24. The decorative layer 22 and the substrate 24 correspondingly form connected surfaces 224. An intersection 25 is formed between the decorative layer 22 and the substrate 24 around the main body 20 on the connected surfaces 224. The protective member 26 may comprise an elastic sheet. The protective member 26 is securely attached to the main body 20 and seals the at least substantially the entire intersection 25 between the decorative layer 22 and the substrate 24 to prevent moisture from entering substantially anywhere between the decorative layer 22 and the substrate 24. The protective member 26 may comprise either an endless band or a strip of material surrounding at least substantially the entire perimeter of main body 20. To attach the protective member 26 securely to the main body 20 an adhesive 27 can be coated on the edges of the protective member 26.

It is to be understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A multi-layered molded article, comprising:
a main body including:
a decorative layer; and
a substrate bonded to the decorative layer, the substrate and the decorative layer correspondingly form a plurality of connected surfaces, an intersection formed between the decorative layer and the substrate surrounding the main body on the connected surfaces; and
a protective member sealing at least substantially the entire intersection between the decorative layer and the substrate to prevent moisture from entering between the decorative layer and the substrate.

2. The multi-layered molded article as claimed in claim 1, wherein the protective member defines a groove around the inside of the protective member, and all connected surfaces of the main body are received in the groove.

3. The multi-layered molded article as claimed in claim 2, wherein the protective member comprises a top rim, a bottom rim and a plurality of sidewalls connecting the top rim and the bottom rim, the top rim, the bottom rim and the sidewalls correspondingly defines the groove.

4. The multi-layered molded article as claimed in claim 3, wherein adhesive material is applied on the edges of the protective member.

5. The multi-layered molded article as claimed in claim 1, wherein the protective member is flexible.

6. The multi-layered molded article as claimed in claim 1, wherein the decorative layer has a bonding surface having a plurality of pores or protrusions that interlock with the substrate.

7. The multi-layered molded article as claimed in claim 1, the substrate being made of one of plastic, rubber, and silicone.

8. The multi-layered molded article as claimed in claim 1, the substrate being made of at least one of acrylonitrile-butadiene-styrene or polycarbonate.

9. The multi-layered molded article as claimed in claim 1, wherein the protective member comprises an elastic sheet that seals at least substantially the entire intersection between the decorative layer and the substrate to prevent moisture from entering substantially anywhere between the decorative layer and the substrate.

10. The multi-layered molded article as claimed in claim 1, wherein the protective member comprises an endless band surrounding at least substantially the entire perimeter of main body.

11. The multi-layered molded article as claimed in claim 1, wherein the protective member comprises a strip of material surrounding at least substantially the entire perimeter of main body.

12. A multi-layered molded article, comprising:
a main body including:
a decorative layer; and
a substrate moldingly bonded to the decorative layer, the substrate and the decorative layer correspondingly form a plurality of connected surfaces; and
a protective member defining a groove around the inside thereof, all connected surfaces of the main body received in the groove to prevent moisture from entering between the decorative layer and the substrate.

13. The multi-layered molded article as claimed in claim 12, wherein the protective member comprises a top rim, a bottom rim and a plurality of sidewalls connecting the top rim and the bottom rim, the top rim, the bottom rim and the sidewalls correspondingly defines the groove.

14. The multi-layered molded article as claimed in claim 12, wherein the decorative layer has a bonding surface having a plurality of pores or protrusions that interlock with the substrate.

15. The multi-layered molded article as claimed in claim 12, the substrate being made of one of plastic, rubber, and silicone.
